(19) United States
(12) Patent Application Publication
(10) Pub. No.: US 2009/0287964 A1
(43) Pub. Date: Nov. 19, 2009

(54) INTERNET ACCESSIBLE TEST SYSTEM

(75) Inventor: John R. Morris, Simi Valley, CA (US)

Correspondence Address: LAW OFFICES OF MIKIO ISHIMARU, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 12/122,677

(22) Filed: May 17, 2008

(51) Int. Cl. G06F 15/16; G06F 11/25

(52) U.S. Cl. 714/39; 709/203

(57) ABSTRACT

An Internet accessible test system including: providing a remote client having an Internet connection; and exercising a tester function across the Internet connection by the remote client.

### TECHNICAL FIELD

The present invention relates generally to communication test systems, and more particularly to a system for remote testing of communication networks.

### BACKGROUND ART

Communication network testers may be used to provide detection, characterization, or other data that may be related to virtually any type of physical process, operation, or environment. For example, communication network testers may be deployed at a variety of locations across an enterprise, and may be used, to name just a few examples, to monitor bandwidth utilization, analyze failure points, or to monitor bit error rate.

In providing these and many other types of functionalities, communication network testers may each be provided with local processing power, memory, and communication capabilities, in addition to being provided with desired tester functions and/or output elements. Such communication network testers may be relatively expensive to support, and may require a skilled local operator to yield informative results. As such, communication network testers may be deployed within and across a large and diverse geographical region or they may be used in a more concentrated area such as a metropolitan area. In each case a skilled operator must transport, connect, and interpret the results of the communication network tester.

The cost and size of such communication network testers, however, generally imply a premium being placed on some or all of the included processing power, memory, or communication capabilities, or use thereof. For example, analysis of a wireless communication base station executed by such communication network tester may impose a relatively large burden on an operator. Typically the skill of the operator will determine how effective the communication network tester will be in the field. A highly skilled operator may be very effective at understanding the information provided by the communication network tester. He may be able to quickly identify and repair field problems in the communication network, but most of his time will be utilized traveling from one problem site to another.

When the cost of support of the communication network is analyzed, the most expensive aspect is the operator inefficiency due to travel between communication network nodes. Much effort has been put into making the communication network tester more sophisticated in order to allow less expensive resources to operate and transport them. The most ingenious testers may be operated by an unskilled operator, but must still be transported from node to node within the communication network. This aspect of communication network support has thwarted every effort to improve the efficiency and response time for communication network analysis and repair.

Thus, a need still remains for an Internet accessible test system that may be permanently installed and operated by a highly skilled operator without wasting the operator's time in travel between nodes. In view of the ever-increasing growth of communication networks, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides an Internet accessible test system including: providing a remote client having an Internet connection; and exercising a tester function across the Internet connection by the remote client.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is diagram of an Internet accessible test system, in an embodiment of the present invention;

FIG. 2 is a functional block diagram of an Internet accessible test system in an embodiment of the present invention;

FIG. 3 is a functional block diagram of a web server for implementing the Internet accessible test system of the present invention;

FIG. 4 is a software block diagram of the web server of FIG. 3;

FIG. 5 is a communication block diagram of a communication structure for the Internet accessible test system of FIG. 2;

FIG. 6 is a functional block diagram of a support daemon structure for supporting the Internet accessible test system of FIG. 2;

FIG. 7 is a flow chart of an Internet accessible test system for operating the Internet accessible test system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

The term “system” as used herein means and refers to the method and to the apparatus of the present invention in accordance with the context in which the term is used. The term “processing” as used herein includes stamping, forging, patterning, exposure, development, etching, cleaning, and/or removal of the material or laser trimming as required in forming a described structure.

The terms keys and buttons are used interchangeably and should be construed broadly. The term physical buttons and hard keys may be used interchangeably. The term soft key may be thought of as a key on a touch screen that is activated by contacting the touch screen in the designated area of the soft key. The term soft key is to be in contrast with the term hard key. Hard keys may be thought of as physical three dimensional keys as opposed to virtual keys on the touch screen. Soft keys, i.e., a corresponding icon, for example, can be located at different positions on a display screen depending on the mode of operation or the actual operation being performed. Hard keys, by contrast, are generally fixed in a specific location, although the function associated with the hard key may be reassigned via various methods. Thus, the terms soft keys and hard keys have relative meaning and soft keys are generally associated with a display and hard keys are generally not.

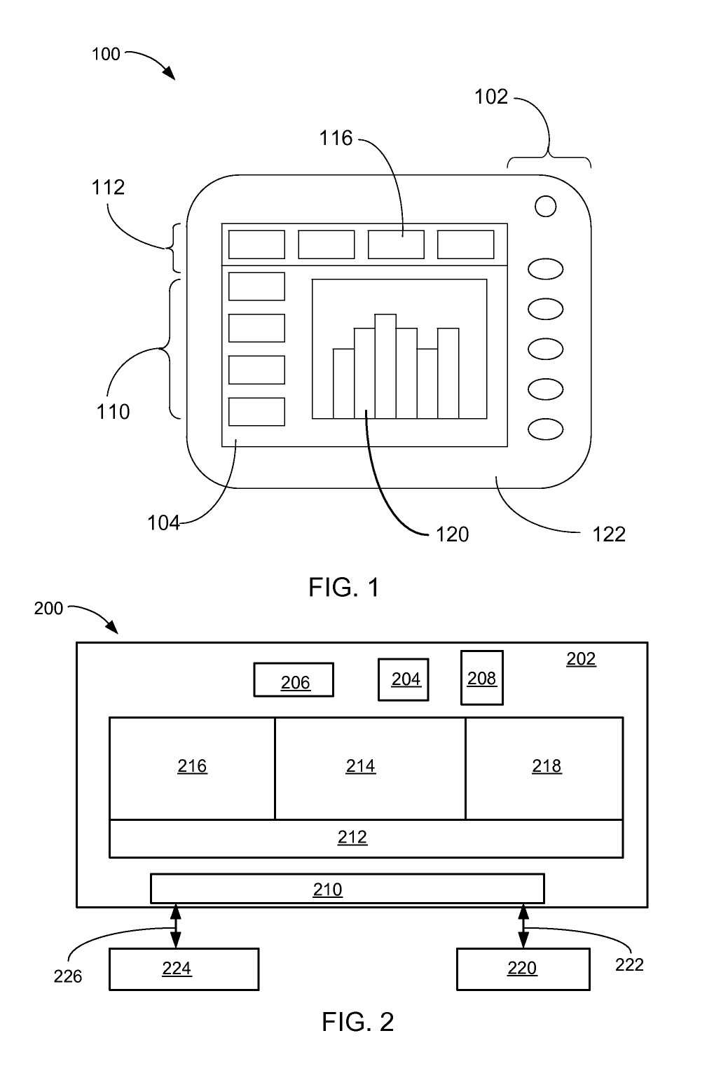

Referring to FIG. 1, therein is shown a diagram of an Internet accessible test system 100 in an embodiment of the present invention. The diagram of the Internet accessible test system 100 depicts hard keys 102, such as the power key, arrow keys, and function select keys, a touch screen 104, function soft keys 108, soft keys 110, a menu bar 112, a menu soft key 116, user data 120 and a chassis 122.

While test equipment is discussed for this application, other uses will be apparent from the teachings disclosed herein. The layout arrangement and the number of the hard keys 102 may vary depending on the function of the equipment. The touch screen 104 is a tactile display screen and it may be divided into sections. In this embodiment example, there are four of the soft keys 110. Each of the soft keys 110 is labeled on the touch screen 104 for its particular function.

The menu bar 112 may constantly be displayed on the touch screen 104. The menu bar 112 may have the menu soft keys 116, such as file open, file save, screen capture, print, toggle background, full screen, mode selection, system settings, default settings, or exit program; or may include specific keys related to the set of tests to be performed by the instrument. The menu soft keys 116 may be used to perform higher level functions in the Internet accessible test system 100.

Referring now to FIG. 2, therein is shown a functional block diagram of an Internet accessible test system 200 in an embodiment of the present invention. The functional block diagram of the Internet accessible test system 200 depicts a hardware platform 202 including a processor 204, such as an 800 MHz XScale, MIPS, ARM, or other embedded processor, a memory 206, local hardware electronics 208, and interface electronics 210. An operating system 212, such as a Linux operating system, may support a web server 214, a client interface 216, and a support daemon 218. The support daemon 218 is a modular set of software or firmware instructions constructed to perform a specific and self contained service for the operating system 212. A tester function 220 may be coupled to the interface electronics 210 by a communication link 222, such as an RS232 or Ethernet interface. A remote client 224 may be coupled to the interface electronics 210 by an Internet connection 226, such as a wired or wireless Ethernet connection.

The operating system 212, the web server 214, the client interface 216 and the support daemon 218 may operate by utilizing the facilities of the hardware platform 202. The operating system 212 may provide file management capabilities and coordination of system assets. The web server 214 may provide access to the tester function 220 for both the client interface 216 and the remote client 224. The client interface 216 may support the local hardware electronics 208. Since the web server 214 provides all of the access to the tester function 220 through a browser interface (not shown), the client interface 216 and the remote client 224 may see the same content and actions.

It has been discovered that the Internet accessible test system 200, of the present invention, may be accessed and operated by any compute platform that supports a browser capable of executing JavaScript. This aspect of the invention represents a dramatic change in the maintenance and support of communication networks. A skilled operator may access a resident tester from anywhere in the world, using an instrument as simple as the latest generation of cell phone or Personal Data Assistant (PDA), running a JavaScript enabled browser. No additional software is required to support the operation of the Internet accessible test system 200.

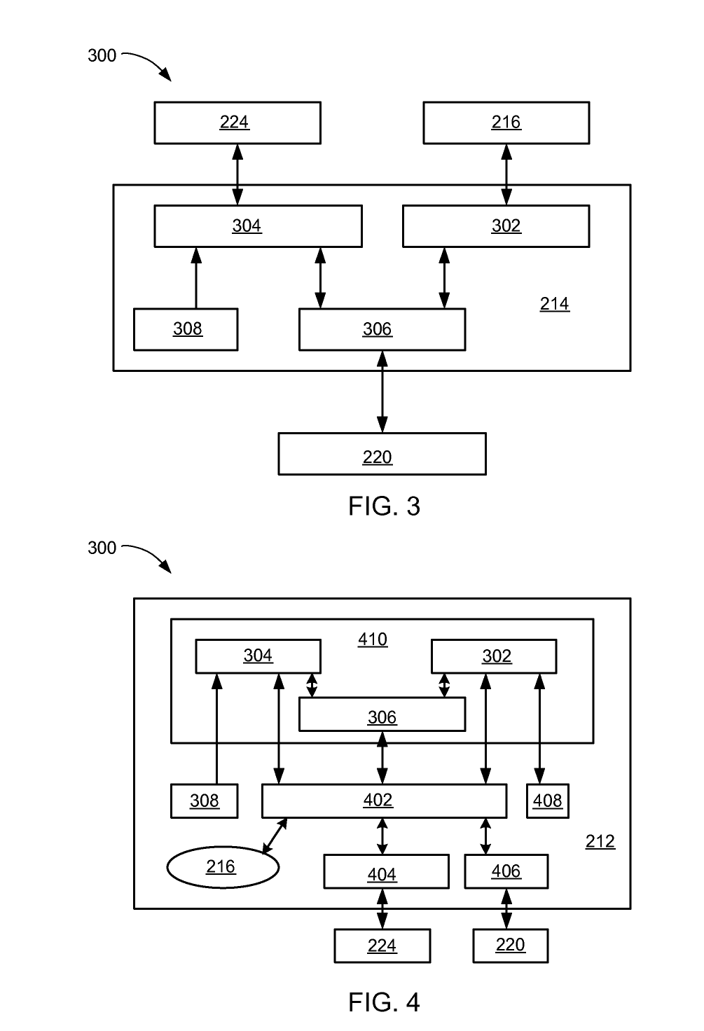

Referring now to FIG. 3, therein is shown a functional block diagram of a web server 300 for implementing the Internet accessible test system 100 of the present invention. The functional block diagram of the web server 300 depicts the client interface 216, the tester function 220, and the remote client 224 coupled to the web server 214. The web server 214 may include a client server 302, such as a transaction language 1 (TL1) server and a remote server 304, such as a Hyper Text Markup Language (HTML) server. The client server 302 and the remote server 304 may be coupled to an instrumentation interface 306 which communicates with the tester function 220. The remote server 304 may access a file memory 308, such as a non-volatile memory, that may store HTML and JavaScript files for communicating with the remote client 224 through the Internet connection 226.

The instrumentation interface 306 provides all of the control to exercise the tester function 220. The same controls are available through the remote server 304 and the client server 302. The remote server 304 may compile HTML and JavaScript messages, stored in the file memory 308, for communicating with the remote client 224. The JavaScript messages display a graphical user interface (GUI) on the remote client 224. The same GUI is made available to the client interface 216 by the client server 302. An aspect of the present invention is that the same GUI is available from the touch screen 104, of FIG. 1, as from the control panel of the remote client 224. The GUI presented on the control panel of the remote client 224 does not require any software beyond the JavaScript enabled web browser.

Referring now to FIG. 4, therein is shown a software block diagram of the web server 300 of FIG. 3. The software block diagram of the web server 300 depicts the operating system 212 providing a Transfer Control Protocol/Internet Protocol (TCP/IP) stack 402 for managing a data transfer to an Ethernet driver 404. The Ethernet driver 404 may monitor the data transfer between the TCP/IP stack 402 and the remote client 224. The TCP/IP stack 402 may also manage the data transfer to a media independent interface (MII) driver 406. The MII driver 406 may monitor the data transfer between the TCP/IP stack 402 and the tester function 220. The operating system 212 may also manage the operations of a serial port driver 408, the file memory 308, and the client interface 216.

A software interpreter 410, such as a Python of Java interpreter, may be used to code and manage the client server 302, the remote server 304, and the instrumentation interface 306. The software interpreter 410 may be an object-oriented, interactive, and extensible programming language that executes under the operating system 212. The software interpreter 410 may be used to implement the client server 302, the remote server 304, and the instrumentation interface 306 in order to assure that there is a common response to operations from the remote client 224 and the client interface 216. Most of the communication between the software interpreter 410, the remote client 224 and the client interface 216 utilizes the TCP/IP stack 402.

It has been discovered that this software structure may provide a substantially similar interface response from the Internet accessible test system 100, of FIG. 1, whether the tester function 220 is accessed by the remote client 224, from anywhere in the world, or by the client interface 216 with the user pushing the soft keys 114, of FIG. 1, on the touch screen 104, of FIG. 1, itself. This aspect of the present invention provides a significant time and resource savings.

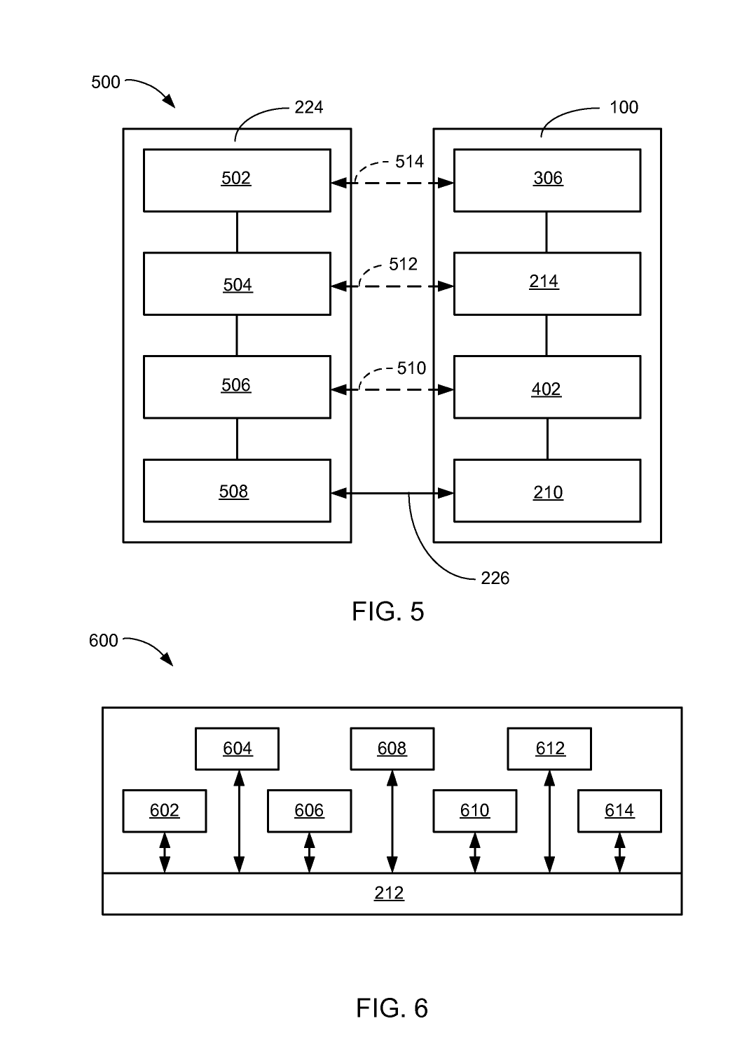

Referring now to FIG. 5, therein is shown a communication block diagram of a communication structure 500 for the Internet accessible test system 200 of FIG. 2. The communication block diagram of the communication structure 500 depicts the remote client 224 providing a graphical user interface (GUI) input 502 to a web browser 504. The web browser 504 may construct a message that is sent to a client TCP/IP stack 506 for transfer to a media controller 508, such as an Ethernet controller. The media controller 508 may send the message across the Internet connection 226 to the Internet accessible test system 100.

The interface electronics 210 may receive the message from the Internet connection 226 and pass it to the TCP/IP stack 402 for accounting. The message may then be passed to the web server 214 for decoding. The decoded message may be in the form of a JavaScript which is passed to the instrumentation interface 306 for execution by the tester function 220, of FIG. 2.

A response message or the result from the tester function 220 may be passed in the opposite direction. Each of the levels of communication has their own link to the corresponding block. While the actual message may only be transferred across the Internet connection 226, each of the blocks has layered a communication layer for its corresponding function. The client TCP/IP stack 506 may include a transfer control protocol (TCP) link 510 which is removed and accounted for by the TCP/IP stack 402. The web browser 504 may add a hyper text transfer protocol (HTTP) layer 512 which may be received and interpreted by the web server 214. The original message compiled by the graphical user interface (GUI) input 502 may be a JavaScript object notation (JSON) 514 which is finally received and interpreted by the instrumentation interface 306.

It is understood that while the dashed arrows may link functions in the remote client 224 with functions in the Internet accessible test system 100 this is an example only. The actual layered message only moves between the remote client 224 and the Internet accessible test system 100 by way of the Internet connection 226.

Referring now to FIG. 6, therein is shown a functional block diagram of a support daemon structure 600 for supporting the Internet accessible test system of FIG. 2. The functional block diagram of the support daemon structure 600 depicts a number of daemons linked to the operating system 212. A daemon is a modular set of software or firmware instructions constructed to perform a specific and self contained service for the operating system 212. By way of an example, FIG. 6 depicts a watchdog daemon 602, a hardware monitor daemon 604, a logger daemon 606, an audio daemon 608, a global positioning system (GPS) daemon 610, a Universal Serial Bus (USB) file server daemon 612, and a test module daemon 614.

The watchdog daemon 602 may be a modular set of software instructions that refresh a one-shot timer in the hardware to prevent a hardware watchdog timer (not shown) from resetting the system. The hardware monitor daemon 604 may be a modular set of software instructions that monitor the temperature of the system, a battery level, power utilization, and power saving features of the system. The logger daemon 606 may be a modular set of software instructions that accept logging messages and stores them in a log file. The audio daemon 608 may be a modular set of software instructions that accept audio packets that may be sent to the audio player of the system. The global positioning system (GPS) daemon 610 may be a modular set of software instructions that return the time and global position information obtained from an on-board GPS chip. The Universal Serial Bus (USB) file server daemon 612 may be a modular set of software instructions that transfers files to or from the universal serial bus. The test module daemon 614 may be a modular set of software instructions that provide access to any of the aspects of the tester function 220.

The current list of daemons is an example only and is not intended to limit or restrict the number or type of daemons available on the actual system. The above description of the daemons is intentionally brief for simplicity of this document. Other functions may be possible and are likely under the listed daemons.

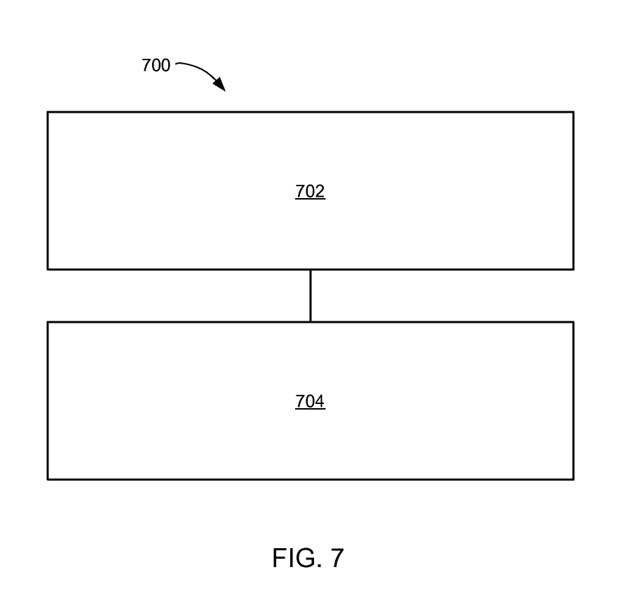

Referring now to FIG. 7, therein is shown a flow chart of an Internet accessible test system 700 for operating the Internet accessible test system 100 in an embodiment of the present invention. The system 700 includes providing a remote client having an Internet connection in a block 702; and exercising a tester function across the Internet connection by the remote client in a block 704.

It has been discovered that the present invention thus has numerous aspects.

An aspect that has been unexpectedly discovered is that the present invention allows a user to manipulate the Internet accessible test system from anywhere in the world. This aspect represents a cost reduction and a simplification of the maintenance of a communication network.

Another aspect of the present invention is that it valuably supports and services the historical trend of reducing costs, simplifying systems, and increasing performance.

These and other valuable aspects of the present invention consequently further the state of the technology to at least the next level.

Thus, it has been discovered that the Internet accessible test system of the present invention furnishes important and heretofore unknown and unavailable solutions, capabilities, and functional aspects for maintaining and repairing communication networks. The resulting processes and configurations are straightforward, cost-effective, uncomplicated, highly versatile and effective, can be surprisingly and unobviously implemented by adapting known technologies, and are thus readily suited for efficiently and economically manufacturing network test devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An Internet accessible test system comprising:
providing a remote client having an Internet connection; and
exercising a tester function across the Internet connection by the remote client.

2. The system as claimed in claim 1 further comprising providing a hardware platform including:
providing a processor;
providing local hardware electronics supported by the processor; and
coupling interface electronics to the processor for communicating with the remote client.

3. The system as claimed in claim 1 further comprising:
providing an operating system for supporting the tester function; and
operating a web server on the operating system for communicating with the remote client.

4. The system as claimed in claim 1 further comprising executing a support daemon for exercising the tester function.

5. The system as claimed in claim 1 further comprising:
providing a web browser in the remote client;
activating a graphical user interface input on the web browser;
activating a client TCP/IP stack by the web browser; and
providing a media controller enabled by the client TCP/IP stack for driving the Internet connection.

6. An Internet accessible test system comprising:
providing a remote client having an Internet connection including activating a web server by the remote client; and
exercising a tester function across the Internet connection by the remote client including:
interrupting an operating system by the Internet connection,
accounting, by a TCP/IP stack, of the Internet connection,
interpreting a hyper text transport protocol layer by the web server, and
activating an instrumentation interface by the operating system for exercising the tester function.

7. The system as claimed in claim 6 further comprising providing a hardware platform including:
providing a processor including launching a client interface;
providing local hardware electronics supported by the processor including coupling a touch screen to the processor through the local hardware electronics; and
coupling interface electronics to the processor for communicating with the remote client including activating a test module daemon from the remote client or the touch screen.

8. The system as claimed in claim 6 further comprising:
launching a test module daemon by the operating system; and
sending a JavaScript object notation to the remote client by the web server.

9. The system as claimed in claim 6 further comprising executing a support daemon for exercising the tester function by selecting a graphic user interface input on a touch screen or the remote client.

10. The system as claimed in claim 6 further comprising:
providing a web browser in the remote client including enabling a JavaScript object notation;
activating a graphical user interface input on the web browser including adding a hyper text transfer protocol layer to the JavaScript object notation;
activating a client TCP/IP stack by the web browser; and
providing a media controller enabled by the client TCP/IP stack for driving the Internet connection including coupling interface electronics.

11. An Internet accessible test system comprising:
a remote client having an Internet connection; and
a tester function coupled to the remote client by the Internet connection.

12. The system as claimed in claim 11 further comprising a hardware platform including:
a processor;
local hardware electronics supported by the processor; and
interface electronics coupled to the processor for communicating with the remote client.

13. The system as claimed in claim 11 further comprising:
an operating system for supporting the tester function; and
a web server on the operating system for communicating with the remote client.

14. The system as claimed in claim 11 further comprising a support daemon for exercising the tester function.

15. The system as claimed in claim 11 further comprising:
a web browser in the remote client;
a graphical user interface input on the web browser; and
a media controller in the remote client for driving the Internet connection from the graphical user interface input.

16. The system as claimed in claim 11 further comprising:
a web server linked to the remote client; and
an instrumentation interface in the web server for exercising the tester function.

17. The system as claimed in claim 16 further comprising a hardware platform including:
a processor for supporting the web server;
local hardware electronics supported by the processor includes a touch screen coupled to the processor through the local hardware electronics; and
interface electronics coupled to the processor for communicating with the remote client includes a test module daemon controlled by the remote client or the touch screen.

18. The system as claimed in claim 16 further comprising a chassis includes:
a hardware platform includes:
a processor,
interface electronics, and
local hardware electronics; and
wherein:
the tester function and the Internet connection coupled to the interface electronics for accessing the tester function from the local hardware electronics or the remote client.

19. The system as claimed in claim 16 further comprising a support daemon for exercising the tester function by a graphic user interface input selected on a touch screen or the remote client.

20. The system as claimed in claim 16 further comprising:
a web browser in the remote client includes a JavaScript object notation enabled;
a graphical user interface input activated on the web browser includes a hyper text transfer protocol layer added to the JavaScript object notation;
a client TCP/IP stack activated by the web browser; and
a media controller enabled by the client TCP/IP stack for driving the Internet connection includes interface electronics coupled.
